(19) United States
(12) Patent Application Publication
(10) Pub. No.: US 2020/0078925 A1
(43) Pub. Date: Mar. 12, 2020

(54) STEPLESS TELESCOPING MECHANISM AND STEPLESS TELESCOPIC SCREWDRIVER

(71) Applicant: XIAMEN NANCHBIT PRECISION TOOLS CO., LTD., XIAMEN (CN)

(72) Inventor: Li Nan WANG, XIAMEN (CN)

(21) Appl. No.: 16/173,568

(22) Filed: Oct. 29, 2018

(30) Foreign Application Priority Data
Sep. 6, 2018 (CN) 201811034786.3

(51) Int. Cl. B25G 1/04; B25B 23/00

(52) U.S. Cl. CPC B25G 1/043; B25B 15/02; B25B 23/0035; B25B 23/0042

(57) ABSTRACT

The invention relates to a stepless telescoping mechanism and a stepless telescopic screwdriver. First, an accommodating cavity is formed in a connecting rod, a connecting handle is placed in the accommodating cavity in a matched manner to form the telescoping mechanism, and the overall length can be adjusted by placing the connecting handle in the accommodating cavity to different depths; second, self-locking bodies and a self-locking piece are arranged, the self-locking bodies are disposed between the self-locking piece and the connecting handle and provided with oblique abutting faces, and thus, the self-locking bodies can be withdrawn in one direction; and meanwhile, in the direction opposite to the withdrawing direction, the self-locking bodies are driven by a frictional force of the connecting handle to abut against a narrowed oblique abutting face so as to be automatically locked, and thus, a unidirectional locking force is provided.

### BACKGROUND OF THE INVENTION

### Technical Field

The invention belongs to the technical field of fastening structures, and particularly relates to a fastening structure of a stepless telescoping mechanism, and a stepless telescopic screwdriver.

### Description of Related Art

Various types of screwdrivers with different functions, lengths and sizes are widely applied to various industries such as the machinery industry, the power industry, the electronics industry, the automobile industry, the eyewear industry, the clock industry and home DYI.

Functionally, combined-type screwdrivers with screwdriver bits capable of being quickly replaced are convenient to use and thus are very popular in the current industry and market.

Nowadays, replaceable screwdriver bits adopted by various assemblies are basically two types. One type of the replaceable screwdriver bits are hexagonal screwdriver bits with a basic dimension of ¼ inch for opposite sides, namely 6.35 mm/5 mm/4 mm/3 mm. The other type of the replaceable screwdriver bits are cylindrical screwdriver bits typically with a dimension of Φ6/Φ5/Φ4/Φ3. Only if a quick-change device corresponding to the hexagonal screwdriver bits is provided with a hexagonal hole matched with the hexagonal screwdriver bits, the hexagonal screwdriver bits can accordingly rotate in use. In order to prevent the hexagonal screwdriver bits from sliding out or falling out of the hexagonal hole, a hole needs to be drilled in the wall of the hexagonal hole of the quick-change device, and a steel ball is placed in the hole and is pressed against the outer wall of the hexagonal screwdriver bits with a spring clamp from the outside; or, a magnet is directly mounted at the bottom of the hexagonal hole to attract the hexagonal screwdriver bits so that the hexagonal screwdriver bits can also be prevented from falling in use.

Moreover, due to the fact that the screwdrivers are used on various occasions, besides the specification change requirement, requirements for the lengths of the screwdrivers are also put forwards according to actual carrying and using demands.

Existing telescopic screwdrivers incompatible with screwdriver bit changing structures are mainly of the following two types: (1) Screwdriver bits cannot be changed, multiple screwdrivers are needed in use, and carrying is very inconvenient; (2) screwdriver bits can be changed by disposing a screwdriver bit changing structure on a telescopic rod in a handle, and the screwdriver bits are changed through the screwdriver bit changing structure; however, due to the fact that stretching-type length adjustment on different levels is achieved through a plurality of clamping grooves formed in the telescopic rod at intervals, the adjustment precision range is narrow, and the application range is limited.

In view of this, it is urgently necessary to provide a stepless telescoping mechanism to solve the problem of the limited length adjustment range of the screwdrivers.

### BRIEF SUMMARY OF THE INVENTION

The objective of the invention is to provide a stepless telescoping mechanism to solve the problems of low precision and poor connecting firmness of existing quick-disassembly connecting mechanisms used for screwdrivers.

The specific scheme is as follows: the stepless telescoping mechanism comprises:

A connecting rod and a connecting handle, wherein the connecting rod is provided with an accommodating cavity extending along the rotation axis of the connecting rod and having an open side, and the connecting handle is placed and received into the connecting rod from the open side.

The stepless telescoping mechanism further comprises a self-locking piece and self-locking bodies, wherein the self-locking piece is disposed on the connecting rod, and the self-locking bodies are movably disposed between the self-locking piece and the connecting handle. The self-locking piece has an abutting face used to abut against the self-locking bodies. In the axial direction of one side of the connecting rod, the distance from the abutting face to the rotation axis of the connecting rod is gradually decreased, so that the abutting face is matched with the connecting handle and the self-locking bodies to form an axial self-locking assembly.

Furthermore, in the direction from the open side of the accommodating cavity to the inside of the accommodating cavity, the distance from the abutting face to the rotation axis of the connecting rod is gradually decreased, so that the connecting handle is automatically locked in the direction of being mounted into the accommodating cavity.

Furthermore, mounting through holes are formed in the wall of the accommodating cavity and penetrate through the wall in the radial direction. The self-locking bodies are disposed in the mounting through holes and can move in the mounting through holes to be close to or away from the connecting handle.

The self-locking piece is a sliding sleeve movably disposed on the connecting rod. The sliding sleeve has a lock position where the sliding sleeve abuts against the self-locking bodies to make the self-locking bodies embedded in the accommodating cavity to abut against the connecting handle and a release position where the sliding sleeve releases the self-locking bodies to make the self-locking bodies separated from the connecting handle.

Furthermore, the self-locking bodies are balls. The sliding sleeve is disposed around the connecting rod and has an end with an expanded open part, so that the abutting face is formed on the inner wall of the open part.

Furthermore, the stepless telescoping mechanism further comprises a spring. The spring is disposed on the connecting rod and applies an acting force to the sliding sleeve to make the sliding sleeve move towards the lock position from the release position.

In the direction opposite to the moving direction of the sliding sleeve under the acting force of the spring, the distance from the abutting face to the rotation axis of the connecting rod is gradually decreased.

Furthermore, the connecting rod comprises a body part and an assembly and disassembly part disposed at one end of the body part. An end, away from the body part, of the assembly and disassembly part is provided with a limiting piece. The mounting through holes are formed in the assembly and disassembly part. The sliding sleeve is disposed around the assembly and disassembly part from a side close to the body part and can abut against the limiting piece. The spring is disposed between the body part and the sliding sleeve so as to abut against the sliding sleeve.

Furthermore, the connecting handle is provided with a cylindrical positioning section. The accommodating cavity is provided with a mounting hole matched with the positioning section. The mounting hole is coaxial with the rotation axis of the connecting rod. The connecting handle is placed in the accommodating cavity, and the positioning section is placed in the mounting hole so as to be matched with the mounting hole, so that the connecting handle is accurately positioned in the axial direction.

The connecting handle is further provided with lock grooves at positions corresponding to the mounting through holes. When the sliding sleeve is located at the lock position, the self-locking bodies stretch into the accommodating cavity and are inserted into the lock grooves, and thus, the connecting handle is fixed in the rotation direction of the connecting rod.

Furthermore, the lock grooves are lock sliding grooves, which are formed in the outer side of the connecting handle and extend approximately in a direction of the rotation axis of the connecting handle. The lock sliding grooves have sections matched with abutting ends of the self-locking bodies.

Furthermore, a plurality of lock sliding grooves is evenly formed in the connecting handle in the circumferential direction. Correspondingly, each self-locking body is disposed at a position, corresponding to one lock sliding groove, of the connecting rod.

The invention further provides a stepless telescopic screwdriver comprising the stepless telescoping mechanism.

One end of the connecting handle forms a screwing end constituting a screwdriver bit. A handheld part is formed on the outer wall of the connecting rod and constitutes a screwdriver handle.

The screwdriver bit is movably disposed in the screwdriver handle. Along the side, towards the screwing end outside the screwdriver handle, of the connecting rod, the distance from the abutting face to the rotation axis of the connecting rod is gradually decreased, so that a bidirectional supporting force is provided by the axial self-locking assembly.

Furthermore, the screwdriver bit has a front end and a rear end which respectively form screwing ends of different specifications.

According to the stepless telescoping mechanism and the stepless telescopic screwdriver, first, the accommodating cavity is formed in the connecting rod, the connecting handle is placed in the accommodating cavity in a matched manner to form the telescoping mechanism, and the overall length can be adjusted by placing the connecting handle in the accommodating cavity to different depths; and second, the self-locking bodies and the self-locking piece are arranged, the self-locking bodies are disposed between the self-locking piece and the connecting handle and are provided with oblique abutting faces, and thus, the self-locking bodies can be withdrawn in one direction; and meanwhile, in the direction opposite to the withdrawing direction, the self-locking bodies are driven by a frictional force of the connecting handle to abut against the narrowed oblique abutting face so as to be automatically locked, and thus, a unidirectional locking force is provided.

Furthermore, the self-locking piece is a sliding sleeve, and the sliding sleeve can be pushed to release the self-locking state; and meanwhile, under an elastic force of a spring, the sliding sleeve always abuts against and presses against the self-locking bodies to apply a frictional resistance in the withdrawing direction, and thus, accidental disengagement of the connecting handle is avoided.

Meanwhile, according to the self-locking structure of the invention, sliding grooves extending in the axial direction are further formed in positions, corresponding to the self-locking bodies, of the connecting handle, and the self-locking bodies are disposed in the sliding grooves in a protruding manner, so that the torque can be transmitted in the rotation direction, the structure is simple, and both fixation in the axial direction and fixation in the circumferential direction are achieved; and moreover, screwdriver bits can be easily replaced.

### BRIEF DESCRIPTION OF THE SEVERAL VIEWS OF THE DRAWINGS

FIG. 1 is a structural view of a stepless telescopic screwdriver in a first embodiment of the invention;

FIG. 2 is a partial longitudinal sectional view of FIG. 1;

FIG. 3 is a partial enlarged view of part A in FIG. 2;

FIG. 4 is a cross sectional view of FIG. 1;

FIG. 5 is a structural view of an assembly and disassembly part with balls.

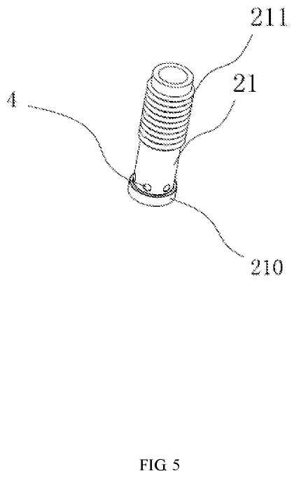

FIG. 6 is a structural view of the assembly and disassembly part with a sliding sleeve.

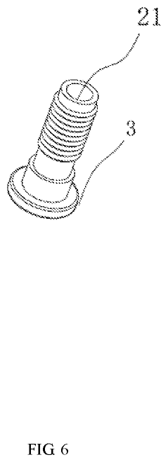

### DETAILED DESCRIPTION OF THE INVENTION

Drawings for a further description of embodiments of the invention are provided. These drawings are one part of the contents disclosed by the invention and are mainly used for illustrating the embodiments and explaining the operating principle of the embodiments in cooperation with relevant contents in the specification. By referring to these contents, those ordinarily skilled in this field can understand other possible embodiments and advantages of the invention. Components in these drawings are drawn not to scale, and similar reference signals generally represent similar components.

The invention is further described as follows in combination with the accompanying drawings and specific embodiments.

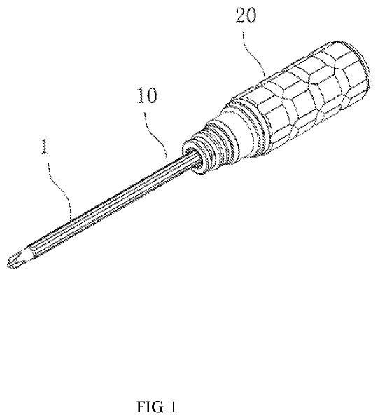

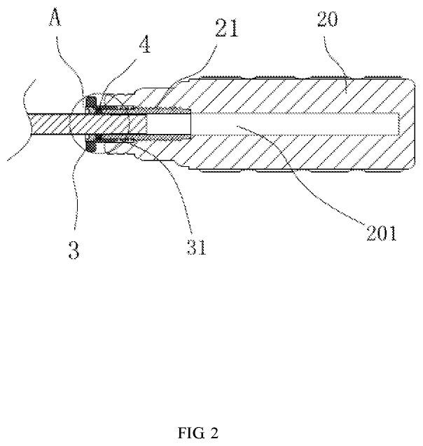

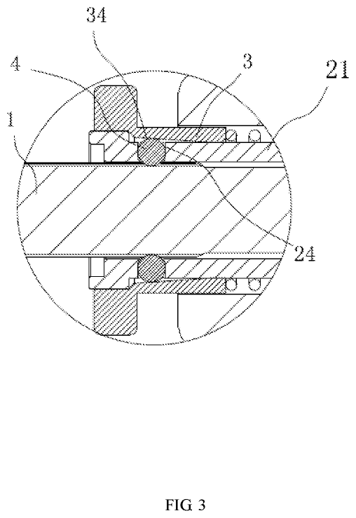

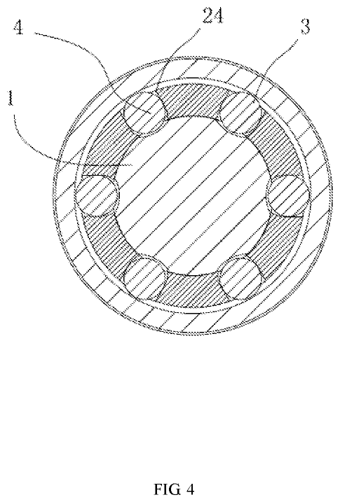

As shown in FIGS. 1-4, this embodiment of the invention provides a stepless telescopic screwdriver with a stepless telescoping mechanism. The wireless telescopic screwdriver comprises a screwdriver bit 1 and a screwdriver handle 20. The screwdriver end 1 has a front end and a rear end respectively forming screwing ends of different specifications. Preferably, the screwing ends are respectively a crossed screwing end and a linear screwing end. The screwdriver bit 1 is movably disposed in the screwdriver handle 20 and can stretch and retract.

Specifically, the screwdriver handle 20 is used as a connecting rod, and the screwdriver bit 1 is used as a connecting handle. The connecting rod (namely the screwdriver handle 20) is provided with an accommodating cavity 201 extending along the rotation axis of the connecting rod and having an open side, and the connecting handle (namely the screwdriver bit 1) is placed and received in the connecting rod from the open side.

The screwdriver handle 20 is further provided with a self-locking piece and self-locking bodies. The self-locking piece is disposed on the connecting rod. The self-locking bodies are movably disposed between the self-locking piece and the connecting handle. The self-locking piece has an abutting face used to abut against the self-locking bodies. In the axial direction of one side of the connecting rod, the distance from the abutting face to the rotation axis of the connecting rod is decreased gradually, so that the abutting face is matched with the connecting handle and the self-locking bodies to form an axial self-locking assembly.

Wherein, in this embodiment, the specific structure of the self-locking bodies and the self-locking piece are as follows:

The self-locking bodies are balls 4. Mounting through holes 24 are formed in the wall of the open side of the accommodating cavity 201 and penetrate through the wall in the radial direction. The self-locking bodies (namely the balls 4) are disposed in the mounting through holes 24, have upper sides and lower sides capable of stretching out of the wall of the accommodating cavity 201 and can roll or move in the mounting through holes to be close to or away from the connecting handle (namely the screwdriver bit 1).

The self-locking piece is a sliding sleeve 3 which is movably disposed around the connecting rod (namely the screwdriver handle 20). The sliding sleeve 3 can slide on the connecting rod and thus has a lock position where the sliding sleeve 3 abuts against the balls 4 to make the balls 4 embedded in the accommodating cavity 201 to abut against the screwdriver bit 1 and a release position where the sliding sleeve 3 releases the self-locking bodies to make the self-locking bodies separated from the screwdriver bit 1.

Wherein, the sliding sleeve 3 is disposed around the connecting rod (namely the screwdriver handle 20) and has an end with an expanded open part, and an oblique abutting face 34 is formed on the inner wall face of the open part.

In the direction from the open side of the accommodating cavity 201 to the inside of the accommodating cavity, the distance from the abutting face 34 to the rotation axis of the connecting rod (namely the screwdriver handle 20) is gradually decreased, so that in the direction of placing the connecting handle (namely the screwdriver bit 1) into the accommodating cavity 201, a surface frictional force of the screwdriver bit 1 drives the balls 4 to move inwards and to roll and rotate; and as the abutting face 34 is obliquely narrowed, the motion of the balls 4 is limited, and thus, the screwdriver bit 1 is automatically locked after being mounted in the accommodating cavity 201.

Namely, along the side, towards the screwing end outside the screwdriver handle 20, of the axis of the screwdriver handle 20, the distance from the abutting face 34 of the sliding sleeve 3 to the rotation axis of the screwdriver handle 20 is gradually decreased, so that a bidirectional supporting force is provided by the axial self-locking assembly, and accordingly, an abutting and pressing force is provided when screws are turned.

In order to achieve automatic locking, the stepless telescopic screwdriver further comprises a spring 31. In this embodiment, the spring 31 is a pressure spring, is disposed around the connecting rod (namely the screwdriver handle 20) and applies an acting force to the sliding sleeve 3 to make the sliding sleeve 3 move towards the lock position from the release position (namely an acting force towards the open side of the accommodating cavity 201), so that in the direction opposite to the moving direction of the sliding sleeve 3 under the acting force of the spring, the distance from the abutting face 34 to the rotation axis of the connecting rod (namely the screwdriver handle 20) is gradually decreased, and thus, the balls 4 are elastically pressed in real time.

To achieve simplest installation, the screwdriver handle 20 comprises a body part and an assembly and disassembly part 21 disposed on the body part in a screwed manner. The assembly and disassembly part 21 is disposed at one end of the body part and located on the open side of the accommodating cavity 201. An end, away from the body part, of the assembly and disassembly part 21 protrudes outwards in the radial direction to form a limiting piece 210. The mounting through holes 24 are formed in the assembly and disassembly part 21. The sliding sleeve 3 is disposed around the assembly and disassembly part 21 from a side close to the body part and can abut against the limiting piece, and the other end of the assembly and disassembly part 21 is provided with threads 211 and is disposed on the body part in a threaded manner. The spring 31 is disposed between the body part and the sliding sleeve 3 and can abut against the sliding sleeve 3 to apply an elastic acting force to the sliding sleeve 3. Such structure is the simplest, and all components can be assembled and fixed through a screwing structure.

Meanwhile, in order to achieve high-precision assembly, the connecting handle (namely the screwdriver bit 1) is provided with a cylindrical positioning section. Preferably, a body part of the cylindrical positioning section is a cylindrical rod. The accommodating cavity 201 is provided with a mounting hole, which is matched with the positioning section and is coaxial with the rotation axis of the connecting rod. The screwdriver bit 1 is disposed in the accommodating cavity 201, the positioning section is disposed in the mounting hole so as to be matched with the mounting hole, and thus, the screwdriver bit 1 is accurately positioned in the axial direction.

In order to achieve axial torque transmission, the screwdriver bit 1 is further provided with lock grooves 10 at positions corresponding to the mounting through holes 24. The lock grooves 10 preferably extend in the length direction of the screwdriver bit 1. When the sliding sleeve 3 is located at the lock position, the self-locking bodies (namely the balls 4) stretch into the accommodating cavity 201 and are inserted into the lock grooves 20, and thus, the connecting handle is fixed in the rotating direction of the connecting rod.

In this embodiment, the screwdriver bit 1 is provided with six lock grooves 10, which are lock sliding grooves formed in the outer side of the connecting handle (namely the screwdriver bit 1) and extending approximately in the length direction of the rotation axis of the screwdriver bit 1. The lock sliding grooves have semicircular sections matched with abutting ends of the self-locking bodies (namely the balls 4), so that the balls 4 can slide in the lock sliding grooves.

Furthermore, a plurality of lock sliding grooves is evenly distributed in the screwdriver bit 1 in the circumferential direction. Correspondingly, each self-locking body (namely each ball 4) is disposed at a position, corresponding to one lock sliding groove, of the screwdriver handle 20.

Although the invention is specifically illustrated and explained with preferred embodiments, those skilled in this field would appreciate that various transformations can be made in form and in detail without deviating from the spirit and scope defined by the claims of the invention, and all these transformations should fall within the protection scope of the invention.

What is claimed is:

1. A stepless telescoping mechanism, comprising:
a connecting rod and a connecting handle, wherein:
the connecting rod is provided with an accommodating cavity extending along a rotation axis and having an open side, and the connecting handle is placed and received in the connecting rod from the open side;
wherein the stepless telescoping mechanism further comprises a self-locking piece and self-locking bodies, the self-locking piece is disposed on the connecting rod, and the self-locking bodies are movably disposed between the self-locking piece and the connecting handle;
the self-locking piece has an abutting face used to abut against the self-locking bodies; and in an axial direction of one side of the connecting rod, a distance from the abutting face to the rotation axis of the connecting rod is gradually decreased, so that the abutting face is matched with the connecting handle and the self-locking bodies to form an axial self-locking assembly.

2. The stepless telescoping mechanism according to claim 1, wherein:
in a direction from the open side of the accommodating cavity to an inside of the accommodating cavity, the distance from the abutting face to the rotation axis of the connecting rod is gradually decreased, so that the connecting handle is automatically locked in a direction of being placed into the accommodating cavity.

3. The stepless telescoping mechanism according to claim 1, wherein:
mounting through holes are formed in a wall of the accommodating cavity and penetrate through the wall in a radial direction; the self-locking bodies are disposed in the mounting through holes and move in the mounting through holes to be close to or away from the connecting handle;
the self-locking piece is a sliding sleeve movably disposed on the connecting rod, and the sliding sleeve has a lock position where the sliding sleeve abuts against the self-locking bodies to make the self-locking bodies embedded into the accommodating cavity to abut against the connecting handle and a release position where the sliding sleeve releases the self-locking bodies to make the self-locking bodies separated from the connecting handle.

4. The stepless telescoping mechanism according to claim 3, wherein:
the self-locking bodies are balls, the sliding sleeve is disposed around the connecting rod and has an end provided with an expanded open part, and the abutting face is formed on an inner wall of the open part.

5. The stepless telescoping mechanism according to claim 3, wherein:
the stepless telescoping mechanism further comprises a spring disposed on the connecting rod and capable of applying an acting force to the sliding sleeve to make the sliding sleeve move towards the lock position from the release position;
in a direction opposite to the moving direction of the sliding sleeve under the acting force of the spring, the distance from the abutting face to the rotation axis of the connecting rod is gradually decreased.

6. The stepless telescoping mechanism according to claim 5, wherein:
the connecting rod comprises a body part and an assembly and disassembly part disposed at one end of the body part; a limiting piece is disposed at an end, away from the body part, of the assembly and disassembly part, and the mounting through holes are formed in the assembly and disassembly part; the sliding sleeve is disposed around the assembly and disassembly part from a side close to the body part and is capable of abutting against the limiting piece; and the spring is disposed between the body part and the sliding sleeve so as to abut against the sliding sleeve.

7. The stepless telescoping mechanism according to claim 3, wherein:
the connecting handle is provided with a cylindrical positioning section, the accommodating cavity is provided with a mounting hole matched with the positioning section, and the mounting hole is coaxial with the rotation axis of the connecting rod; the connecting handle is placed into the accommodating cavity, and the positioning section is placed into the mounting hole so as to be matched with the mounting hole, so that the connecting handle is accurately positioned in an axial direction;
the connecting handle is further provided with lock grooves at positions corresponding to the mounting through holes; when the sliding sleeve is located at the lock position, the self-locking bodies stretch into the accommodating cavity and are inserted into the lock grooves, so that the connecting handle is fixed in the rotation direction of the connecting rod.

8. The stepless telescoping mechanism according to claim 7, wherein:
the lock grooves are lock sliding grooves formed in an outer side of the connecting handle and extending approximately in a direction of a rotation axis of the connecting handle, and the lock sliding grooves have sections matched with abutting ends of the self-locking bodies.

9. The stepless telescoping mechanism according to claim 8, wherein:
the multiple lock sliding grooves are evenly distributed in the connecting handle in a circumferential direction; and correspondingly, each said self-locking body is disposed at a position, corresponding to one said lock sliding groove, of the connecting rod.

10. A stepless telescopic screwdriver, comprising the stepless telescoping mechanism according to claim 1 wherein,
a screwing end is formed by one end of the connecting handle and constitutes a screwdriver bit, and a handheld part is formed on an outer wall of the connecting rod and constitutes a screwdriver handle;
the screwdriver bit is movably disposed in the screwdriver handle; and along a side, towards the screwing end outside the screwdriver handle, of an axis of the screwdriver handle, the distance from the abutting face to the rotation axis of the screwdriver handle is gradually decreased, so that a bidirectional supporting force is provided by the axial self-locking assembly.
